(19) United States
(12) Patent Application Publication
(10) Pub. No.: US 2016/0065929 A1
(43) Pub. Date: Mar. 3, 2016

(54) SUBTITLING FOR STEREOSCOPIC IMAGES

(71) Applicants: Jesus BARCONS-PALAU, Burbank, CA (US); Joan LLACH, Cesson Sevigne (FR); Louai Marwan AL-KHANJI, Oulu (FI)

(72) Inventors: Jesus BARCONS-PALAU, Burbank, CA (US); Joan LLACH, Cesson Sevigne (FR); Louai Marwan AL-KHANJI, Oulu (FI)

(73) Assignee: THOMSON LICENSING, Issy les Moulineaux (FR)

(21) Appl. No.: 13/578,774

(22) PCT Filed: Dec. 13, 2010
(86) PCT No.: PCT/US2010/003150

§ 371 Date: May 2, 2013

Related U.S. Application Data
(60) Provisional application No. 61/307,779, filed on Feb. 24, 2010.

(51) Int. Cl. H04N 13/00; H04N 9/87

(52) U.S. Cl. CPC H04N 13/007; H04N 13/004; H04N 13/0051; H04N 13/0066; H04N 9/8715

(57) ABSTRACT

A method, apparatus and system of the present invention enable the location of subtitles for a stereoscopic image and a selection of the disparity of stereo subtitles to ensure proper display of the subtitles within frames of the stereoscopic content. In one embodiment, the functionality of the concepts of the present invention is based on a player capable of displaying stereo content by reading two streams (one for the left view, one for the right view) and mixing the streams in real time using a mode supported on a 3D display (i.e. line interleaved, checkerboard pattern) based on received file information and inserting the subtitle in the frames by rendering the values in the received file information.

### CROSS-REFERENCE TO RELATED APPLICATIONS

This application claims the benefit of U.S. Provisional Application No. 61/307,779, filed Feb. 24, 2010.

### FIELD OF THE INVENTION

The present invention generally relates to subtitles and, more particularly, to a method, apparatus and system for implementing subtitles for 3D content.

### BACKGROUND OF THE INVENTION

For two-dimensional content, subtitles are usually placed in the same location, for example, at the bottom of a frame or sequence of frames. In contrast, for three-dimensional content, it makes sense to place the subtitles in a particular area of a frame or sequence of frames depending on the elements in the frame(s).

Another factor to consider for three-dimensional content is the disparity involved with displaying three-dimensional content. More specifically, while in two-dimensional content both eyes receive the same frame, for three-dimensional content each eye receives a different frame. As such, the subtitles for three-dimensional content can be rendered in different positions on the horizontal axis. The difference of horizontal positions is called disparity.

As such, because there are many more variables that have to be controlled and taken into account, providing subtitles for three-dimensional content is much more complicated than for two-dimensional content.

### SUMMARY OF THE INVENTION

Embodiments of the present invention address the deficiencies of the prior art by providing a method, apparatus and system for providing subtitles for stereoscopic content. In various embodiments of the present invention, a system of the present invention enables an operator to locate the subtitles for a stereoscopic image and to choose the disparity of stereo subtitles to ensure proper display.

In one embodiment of the present invention, the functionality of the concepts of the present invention is based on a player capable of displaying stereo content by reading two streams (one for the left view, one for the right view) and mixing the streams in real time using a mode supported on a 3D display (i.e. line interleaved, checkerboard pattern) based on received file information.

More specifically, in one embodiment of the present invention, a method for the positioning of subtitles in three-dimensional content includes receiving at least one left-eye view frame of three-dimensional content in which a subtitle is to be inserted, receiving at least one corresponding right-eye view frame of the three-dimensional content in which a subtitle is to be inserted, receiving file information identifying a subtitle to be inserted into the frames and at least a respective position in the frames for inserting the subtitle and providing a means for inserting the subtitle in the frames by rendering the values in the received file information and for real-time manipulation of the position of the subtitle in the frames by altering values in the received file information. The method can further include mixing the subtitled at least one left-eye view frame with the subtitled at least one right-eye view frame.

In an alternate embodiment of the present invention, a subtitling device for positioning of subtitles in three-dimensional content includes a memory for storing program routines and data files and a processor for executing program routines. In such an embodiment of the present invention, the processor, when executing the program routines, is configured to perform the steps of inserting a subtitle in at least one left-eye view frame and at least one corresponding right-eye view frame of the three-dimensional content by rendering values in a file containing information identifying a subtitle to be inserted into the frames and at least a respective position in the frames for inserting the subtitle, and performing real-time manipulation of the position of the subtitle in the frames by altering values in the file.

In an alternate embodiment of the present invention, a system for positioning of subtitles in three-dimensional content includes a source of at least one left-eye view frame of the three-dimensional content in which a subtitle is to be inserted, a source of at least one right-eye view frame of the three-dimensional content in which a subtitle is to be inserted, and a subtitling device for receiving at least one left-eye view frame of the three-dimensional content in which a subtitle is to be inserted, receiving at least one right-eye view frame of the three-dimensional content in which a subtitle is to be inserted, receiving file information identifying a subtitle to be inserted into the frames and at least a respective position in the frames for inserting the subtitle, and inserting the subtitle in the frames by rendering the values in the received file information and for real-time manipulation of the position of the subtitle in the frames by altering values of the received file information.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system for providing subtitles for stereoscopic content in accordance with an embodiment of the present invention;

FIG. 2 depicts a high level diagram of a graphical user interface suitable for use in the system of FIG. 1 in accordance with an embodiment of the present invention;

FIG. 3a depicts a representative diagram of a subtitle inserted in left and right views of a stereoscopic image in accordance with an embodiment of the present invention;

FIG. 3b depicts a more detailed diagram of the subtitle inserted in the left and right views of the stereoscopic image of FIG. 3a;

FIG. 4 depicts a representative diagram of a rendering window for the stereoscopic image of FIG. 3a with the inserted subtitles in accordance with an embodiment of the present invention;

FIG. 5 depicts a flow diagram of a method for positioning of subtitles in three-dimensional content in accordance with an embodiment of the present invention; and

FIG. 6 depicts a high level block diagram of an embodiment of a subtitle device suitable for executing the inventive methods and processes of the various embodiments of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for providing subtitles for stereoscopic content. Although the present invention will be described primarily within the context of providing subtitles for three-dimensional content using an information file, the specific embodiments of the present invention should not be treated as limiting the scope of the invention. It will be appreciated by those skilled in the art and informed by the teachings of the present invention that the concepts of the present invention can be applied to substantially any stereoscopic image content and receiving information regarding the subtitle in other forms in addition to a file structure.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

As previously mentioned, adding subtitles to stereoscopic content, such as three-dimensional (3D) content is much more complicated than adding subtitles to two-dimensional content. For example, for 3D content, it makes sense to place the subtitles in a particular area of a frame or sequence of frames depending on the elements/objects in the frame(s) such that the subtitles are not blocked. In addition, for 3D content, the disparity involved with displaying the 3D content has to be taken into account. As such, the subtitles for three-dimensional content can be rendered in different positions on the horizontal axis.

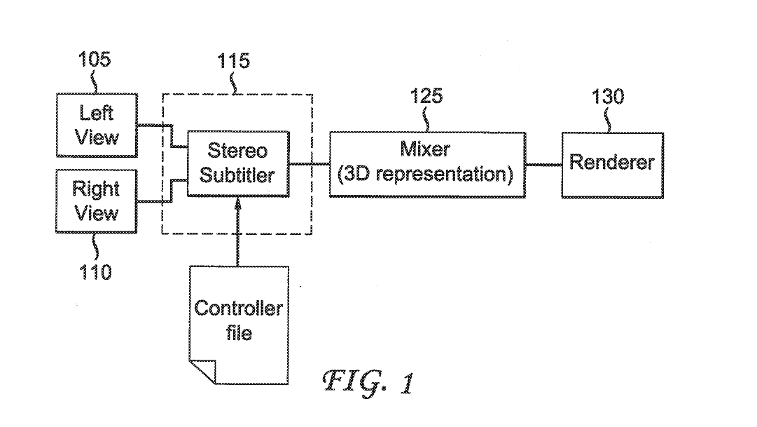

FIG. 1 depicts a high level block diagram of a system 100 for providing subtitles for stereoscopic (3D) content in accordance with an embodiment of the present invention. The system 100 of FIG. 1 illustratively includes a source of a left-eye view 105 and a source of a right-eye view 110 of the 3D content. The system 100 of FIG. 1 further includes a stereo subtitle device 115, a mixer 125 and a renderer 130 for rendering stereoscopic (3D) images.

In the system 100 of FIG. 1, content from the left-eye view source 105 and the right-eye view source 110 are communicated through the stereo subtitle device 115 to the mixer 125. In one embodiment of the present invention, the mixer 125 of the system 100 of FIG. 1 is capable of mixing the content from two sources 105, 110 using a mode supported on a 3D display, for example, a line interleaved or checkerboard pattern.

As depicted in the system 100 of FIG. 1, the stereo subtitle device 115 receives the content from the left-eye view source 105 and the right-eye view source 110 along with an information file (e.g., a text file) containing information regarding the subtitles to be inserted into the stereoscopic (3D) images. In one embodiment of the present invention, the information file communicated to the stereo subtitle device 115 can contain such information as:

Subtitle image file (e.g., a TIFF file).

Timestamps (initial and final).

Position (X, Y).

Disparity (Z).

That is, in one embodiment of the present invention, the stereo subtitle device receives stereoscopic images and information regarding a subtitle and a location and position in the received stereoscopic images in which a subtitle(s) is to be inserted. The received information further includes disparity information for the stereoscopic images. In one embodiment of the present invention, the received information takes the form of a control file and is communicated along with the stereoscopic images. In alternate embodiments of the present invention, the control information is communicated inside the stereoscopic images as metadata. In alternate embodiments of the present invention, such control information can be stored in a local or remote storage medium or device such that when the stereo subtitle device of the present invention receives stereoscopic images, the stored information can be compared to information identifying the received images to determine if any of the stored control information files are data that is meant to be applied to received stereoscopic content.

In accordance with the concepts of embodiments of the present invention, the stereo subtitle device of the present invention utilizes received control file information to locate subtitles in received stereoscopic images. In one embodiment of the present invention, the control file information can be utilized to initially locate subtitles in stereoscopic images in which no previous subtitles have been inserted or, in yet alternate embodiments of the present invention, the received control file information can be utilized to adjust a position of subtitles already existing in received stereoscopic images. For example, in the system 100 of FIG. 1, the stereo subtitle device 115 reads the received control file and, illustratively, the TIFF image file containing the subtitle(s) and renders the subtitle for all the frames between the initial and final timestamps with the proper position and disparity.

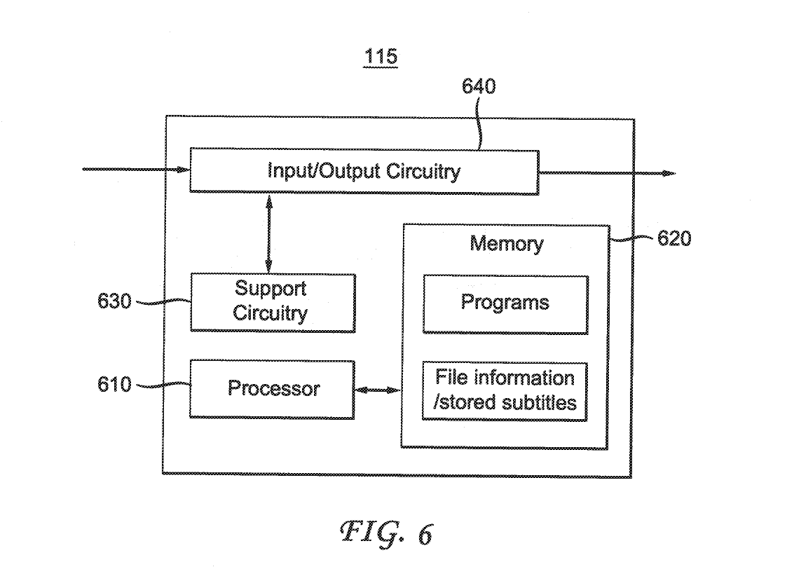

FIG. 6 depicts a high level block diagram of an embodiment of a subtitle device 115 suitable for executing the inventive methods and processes of the various embodiments of the present invention. More specifically, the subtitle device 115 of FIG. 6 illustratively comprises a processor 610 as well as a memory 620 for storing control programs, file information, stored media and the like. The subtitling device 115 cooperates with conventional support circuitry 630 such as power supplies, clock circuits, cache memory and the like as well as circuits that assist in executing the software routines stored in the memory 620. As such, it is contemplated that some of the process steps discussed herein as software processes may be implemented within hardware, for example, as circuitry that cooperates with the subtitling device 115 to perform various steps. The subtitle device 115 also contains input-output circuitry 640 that forms an interface between various functional elements communicating with the subtitle device 115 such as mixers, displays, content sources and the like.

Again, although the subtitle device 115 of FIG. 6 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

The concepts of the present invention enable an operator/user to manipulate the position and disparity of the subtitles in real time by manipulating the values in the information/control file. Such an application in accordance with the concepts of the present invention achieves better results in the placement and look of subtitles for stereoscopic content and results in a faster process compared with former techniques of subtitling 3D content, because an operator/user can immediately see how changes in the values of the information file affect the final result of the subtitles in the stereoscopic image.

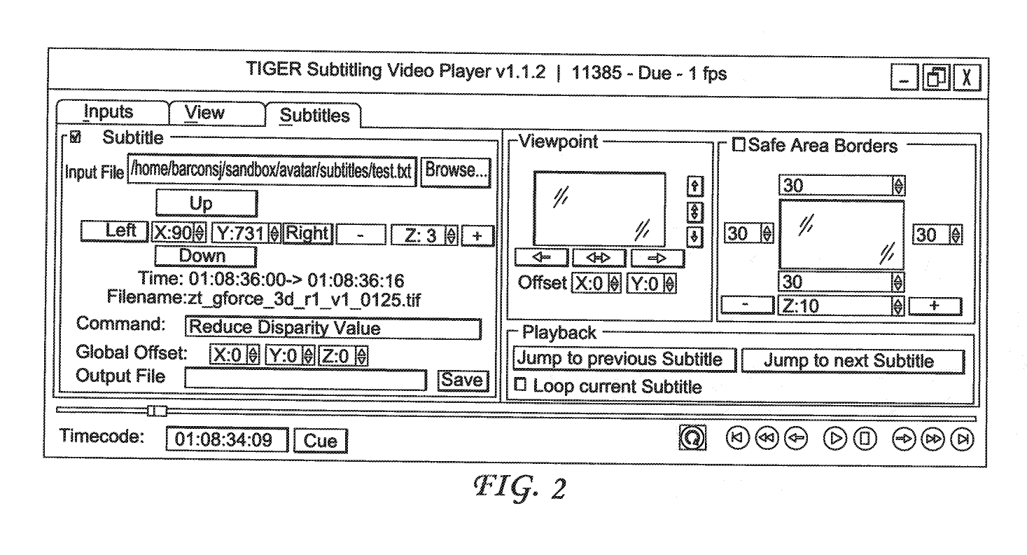

For example, FIG. 2 depicts a high level diagram of a graphical user interface (GUI) suitable for use with the subtitling device 115 in the system 100 of FIG. 1 in accordance with an embodiment of the present invention. As depicted in FIG. 2, a GUI in accordance with an embodiment of the present invention can include a browser to locate a file to load, left and right position indicators for a subtitle, up and down buttons to offset the left and right positions, a global offset indicator and x, y, z adjustment buttons, a text bar for naming an output file, a time and filename indicator, and a timecode indicator and cue button. In accordance with an embodiment of the present invention, the z adjustment is used to adjust the disparity or position of a subtitle in a frame.

The GUI of FIG. 2 further illustratively includes a playback viewport including play/pause, forward and reverse buttons. The viewport area of the GUI of FIG. 2 further includes x and y fine tuning offset buttons and indicators. The playback of a subject subtitle can be configured to playback in a loop or a previous or subsequent subtitle can be selected using respective buttons. As depicted in FIG. 2, in another area of the GUI of FIG. 2, a user can optionally configure safe area borders for a subtitle.

More specifically, in one embodiment of the present invention, a safe subtitle area can be configured on the frames of stereoscopic content. When such an area is designated by, for example, using the GUI of FIG. 2, only elements inside that area are guaranteed to be rendered on any compliant display. For example, in one embodiment of the present invention, elements inside the safe subtitle area are guaranteed to be rendered over any other objects of a frame such that the subtitle is not blocked by another object. As such, such a capability in accordance with the present invention is useful for a user/operator to guarantee that the subtitles within that defined area will be fully rendered. It should be noted that because the content is stereo content, the “safe subtitle area” has to be rendered with a specific disparity to be in front objects on a scene that may block the view of the subtitles. Such disparity values can be selected using the GUI of FIG. 2.

As depicted in FIG. 2, a GUI of the present invention can further include a comments section for inserting comments for subtitles. In one embodiment of the present invention, the comments are displayed on the GUI and are stored with the controller file information. In addition, the concepts of the present invention can be used to change a 3D rendering mode on the fly (i.e. change from line-interleaved mode to checkerboard pattern), enabling the display of subtitles using different displays/formats.

In addition, when a frame size of content is larger than the rendering window (e.g., 2048×1200 and 1920×1080), only the content under a viewport is rendered. In one embodiment of the present invention, the user can change the viewport in real time. In one exemplary embodiment of the present invention, the motion granularity on the vertical axis is 2 pixels to avoid changing the views (i.e. when using line-interleaved mode, a change on the views will carry to invert the disparity on the screen).

In accordance with various embodiments of the present invention, a stereo subtitle device 115 of the present invention, via for example the GUI of FIG. 2 can include the following functionalities:
To automatically estimate the disparity and position of the subtitles by determining or being informed of the disparity between the stereoscopic images.
To automatically estimate the disparity of a “safe subtitle” area.
To notify an operator of subtitles which disparity and position can lead to problems (i.e. subtitles rendered behind objects, subtitles rendered with a disparity higher than a certain threshold . . . ).
To notify an operator about mismatches between timestamps and audio (by using audio processing) and recommend new timestamps.

In one embodiment of the present invention, the information determined and received by the stereo subtitle device 115 is communicated to the mixer 125 and/or the renderer 130 for processing the stereoscopic images and subtitles for display.

Although in the system 100 of FIG. 1, the stereo subtitle device 115 is illustratively a separate component in the system 100, in alternate embodiments of the present invention, the stereo subtitle device 115 can be an integrated component of the mixer 125 or the renderer 130.

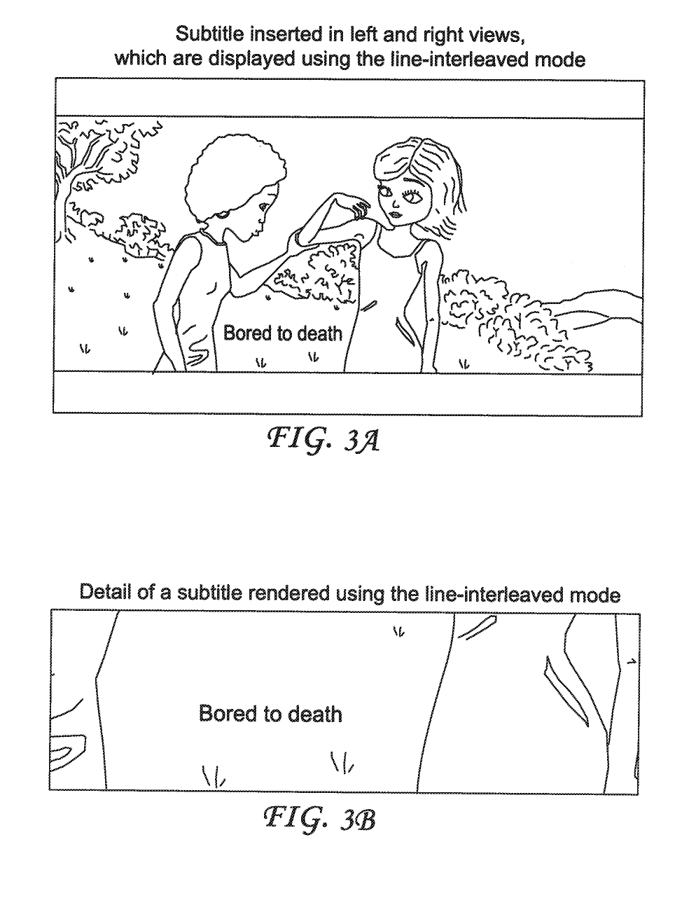

FIG. 3a depicts a representative diagram of a subtitle inserted in left and right views of a stereoscopic image in accordance with an embodiment of the present invention. More specifically, as depicted in FIG. 3a, the stereo subtitle device 115 of the present invention is implemented to insert and position subtitles into the left and right images of the stereoscopic images for proper display.

FIG. 3b depicts a more detailed diagram of the subtitle inserted in the left and right views of the stereoscopic image of FIG. 3a. As depicted in FIG. 3b, the inserted subtitles appear correctly in the stereoscopic images due to the manipulation of the position and disparity of the subtitles enabled by the stereo subtitle device 115 and the components of the system 100 of FIG. 1.

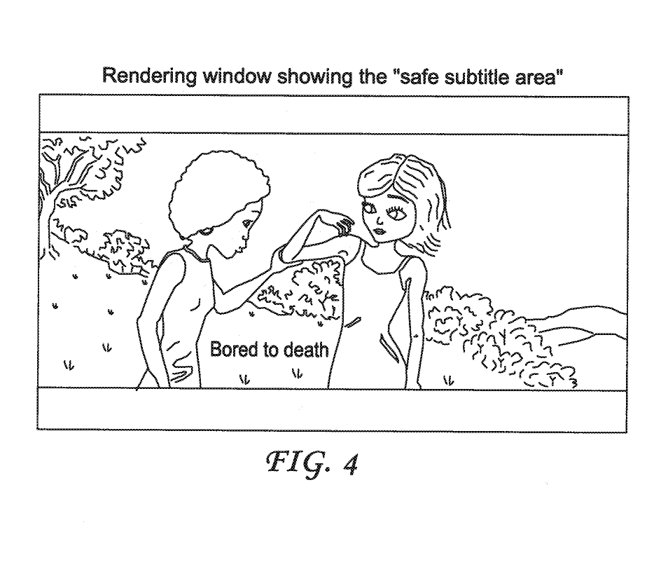

FIG. 4 depicts a representative diagram of a rendering window for the stereoscopic image of FIG. 3a with the inserted subtitles in accordance with an embodiment of the present invention. More specifically, FIG. 4 depicts a frame of a stereoscopic image having a subtitle inserted in the frames in a designated “safe subtitle” area. As previously described, subtitles inside the safe subtitle area are guaranteed to be rendered on any compliant display.

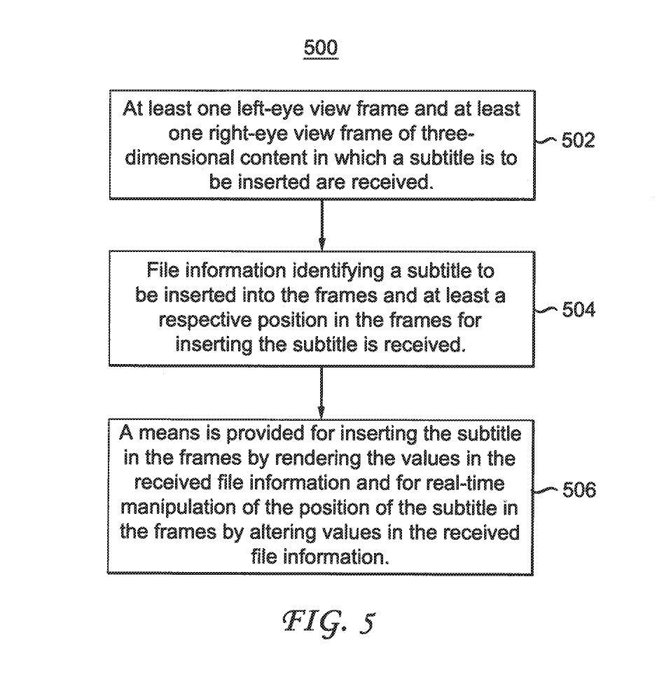

FIG. 5 depicts a flow diagram of a method for positioning of subtitles in three-dimensional content in accordance with an embodiment of the present invention. The method 500 begins at step 502 during which at least one left-eye view frame and at least one right-eye view frame of three-dimensional content in which a subtitle is to be inserted is received. The method 500 then proceeds to step 504.

At step 504, file information identifying a subtitle to be inserted into the frames and at least a respective position in the frames for inserting the subtitle is received. The method 500 then proceeds to step 506.

At step 506, a means is provided for inserting the subtitle in the frames by rendering the values in the received file information and for real-time manipulation of the position of the subtitle in the frames by altering values in the received file information. The method 500 can then be exited.

In accordance with the concepts of the present invention, a user can optionally set an offset to be applied to the control file information, using, for example, the GUI of FIG. 2 in order to change the position and disparity of all the subtitles in, for example a controller file. Such a feature is particularly useful when there are different versions of the same content (i.e. different resolutions) and the subtitles are to be applied to all versions.

Having described various embodiments for a method, apparatus and system for providing subtitles for stereoscopic content (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for positioning of subtitles in three-dimensional content, comprising:
receiving at least one left-eye view frame of said three-dimensional content in which a subtitle is to be inserted;
receiving at least one right-eye view frame of said three-dimensional content in which a subtitle is to be inserted;
receiving file information identifying a subtitle to be inserted into said frames and at least a respective position in the frames for inserting the subtitle; and
providing a means for inserting the subtitle in said frames by rendering the values in said received file information and for real-time manipulation of the position of said subtitle in said frames by altering values in said received file information.

2. The method of claim 1, wherein said method further comprises mixing said subtitled at least one left-eye view frame with said subtitled at least one right-eye view frame.

3. The method of claim 2, wherein said frames are mixed using at least one of a line interleaved and checkerboard pattern.

4. The method of claim 1, wherein said method further comprises rendering said subtitled, three-dimensional content.

5. The method of claim 1 wherein said file information comprises metadata communicated with at least one of the at least one left-eye view frame and at least one right-eye view frame of said three-dimensional content.

6. The method of claim 1, wherein said file information is stored in a storage means accessible to said means for inserting.

7. A subtitling device for positioning of subtitles in three-dimensional content, comprising:
a memory for storing program routines and data files; and
a processor for executing said program routines, said processor, when executing said program routines, configured to perform the steps of:
inserting a subtitle in at least one left-eye view frame and at least one corresponding right-eye view frame of said three-dimensional content by rendering values in a file containing information identifying a subtitle to be inserted into said frames and at least a respective position in said frames for inserting the subtitle; and
performing real-time manipulation of the position of the subtitle in said frames by altering values in the file.

8. The subtitling device of claim 7, wherein said file is stored in the memory of said subtitling device.

9. The subtitling device of claim 7, wherein said file is received as metadata communicated with said three-dimensional content.

10. The subtitling device of claim 7, wherein said subtitling device comprises a graphical user interface for enabling the inserting of the subtitle and real-time manipulation of the position of the subtitle in the frames of said three-dimensional content.

11. The subtitling device of claim 7, further comprising a user interface for enabling a user to alter values in said received file.

12. A system for positioning of subtitles in three-dimensional content, comprising:
a source of at least one left-eye view frame of said three-dimensional content in which a subtitle is to be inserted;
a source of at least one right-eye view frame of said three-dimensional content in which a subtitle is to be inserted; and a subtitling device for:
receiving at least one left-eye view frame of said three-dimensional content in which a subtitle is to be inserted;
receiving at least one right-eye view frame of said three-dimensional content in which a subtitle is to be inserted;
receiving a file containing information identifying a subtitle to be inserted into said frames and at least a respective position in the frames for inserting the subtitle; and
inserting the subtitle in said frames by rendering the values in said received file and for real-time manipulation of the position of said subtitle in said frames by altering values in said received file.

13. The system of claim 12, further comprising a mixer for mixing a subtitled at least one left-eye view frame with a corresponding subtitled at least one right-eye view frame.

14. The system of claim 12, further comprising a rendering device for rendering said subtitled, three-dimensional content.

15. The system of claim 12, further comprising a user interface for enabling a user to alter values in said received file.
